(19) United States
(12) Patent Application Publication
(10) Pub. No.: US 2026/0298016 A1
(43) Pub. Date: Oct. 1, 2026

(54) DURABLE DOOR FRAME

(71) Applicant: Jerry Monts De Oca, Tampa, FL (US)

(72) Inventor: Jerry Monts De Oca, Tampa, FL (US)

(21) Appl. No.: 19/246,780

(22) Filed: Jun. 24, 2025

Related U.S. Application Data
(60) Provisional application No. 63/779,388, filed on Mar. 28, 2025.

(51) Int. Cl. E06B 1/34; B32B 3/26; B32B 7/12; B32B 27/18; B32B 27/30; B32B 27/32; E06B 1/26

(52) U.S. Cl. CPC E06B 1/34; B32B 3/263; B32B 7/12; B32B 27/18; B32B 27/302; B32B 27/304; B32B 27/308; B32B 27/32; E06B 1/26; B32B 2250/44; B32B 2262/0261; B32B 2270/00; B32B 2272/00; B32B 2307/7376

(57) ABSTRACT

A door frame assembly that is durable and resistant to damage from moisture and ultraviolet light exposure, thermally insulating, and convenient to install and repair while providing the ability to manufacture the door frame in a cost effective manner. The door frame includes a base and a cover that partially encloses the base. The cover includes a nose, a leg, and a kerf to fit a weatherstripping material, a stop portion, a step portion, and a face. The cover is optionally fixed to the base using one or more attachment tabs that frictionally engage rabbeted edges formed in the base or using adhesives or lamination.

### TECHNICAL FIELD AND BACKGROUND

The present invention relates generally to entryway components, and more particularly, to durable door frames.

Conventional door frames are made of porous materials such as wood that soak up moisture or are prone to degradation from exposure to UV light. As a result, door frames are susceptible to material decay or damage from mold and mildew. The exterior components of a door frame are in some instances coated with paint or a thin cover that is impervious to moisture, but moisture still reaches the interior of the door frame resulting in component decay and failure. Furthermore, not only is the door frame susceptible to decay and damage, the underlying door frame or wall may also be exposed to mold and mildew.

Various cover materials can be used, such as aluminum or plastics, but existing materials demonstrate certain disadvantages. Aluminum and other metallic materials are expensive and subject to making “creaking” noises if the cover is not fitted properly or is subject to deformation over time. Plastic materials are often not resistant to impact damage or are susceptible to deformation under heat. Stiffening components made from metal or laminated wood can improve structural integrity, but such components add to the time, expense, and complexity of installation, and the components can interfere with hardware fasteners used to anchor door frames.

It is, therefore, an object of the present invention to provide a door frame assembly that is durable and resistant to damage from moisture and ultraviolet light exposure, thermally insulating, aesthetically pleasing, significantly lighter and easier to transport than existing door frames, and convenient to install and repair all while providing the ability to manufacture the door frame in a cost-effective manner.

### SUMMARY

Disclosed is a door frame assembly that has a cover that completely seals a base portion when the door frame assembly is installed in an entryway, thereby preventing moisture intrusion through or around the cover to an underlying base portion. The cover defines a cavity, and the base is housed within the cavity. The cover includes a step portion having a rear face, a stop portion, and a step portion outer surface that extends along a first axis from the rear face to the stop portion. The rear face extends away from the step portion outer surface along a second axis that is perpendicular to the first axis. The rear face is coupled to the step portion outer cover and extends a first length along the second axis and terminates at a first free end that is proximal to where the door frame assembly is mounted to the interior surface of an entryway.

The stop portion of the cover extends along the second axis away from the top surface to a kerf. The kerf comprises an interior surface that defines a channel and a channel opening. The cover leg includes a leg outer surface, wherein the leg outer surface extends from the channel opening along the first axis to a nose. The nose extends away from the leg outer surface along the second axis. The nose is coupled to the leg outer surface and extends a second length along the second axis and terminates at a second free end. The cavity is at least partially enclosed by the rear face, the step portion, the kerf, the leg, and the nose.

The base that is configured to be housed at least partially within the cavity such that the cavity encloses all surfaces of the base except for the mounting surface. In this manner, the mounting surface is coterminal with the nose free end and the rear face free end. The cover can be secured to the base using adhesives, a layer of lamination, or using attachment tabs.

In one embodiment using attachment tabs, the cover includes a first attachment tab formed at the rear face first free end and a second attachment tab formed at the nose second free end. In this embodiment, the base mounting surface extends along the first axis between a rear wall and a base nose, the rear wall extends away from the mounting surface along the second axis, and the base nose extends away from the mounting surface along the second axis. The base includes a first rabbeted edge formed proximal to an intersection of the mounting surface and the rear wall, and a second rabbeted edge formed proximal to an intersection of the mounting surface and the base nose. The cover is secured to the base by the first attachment tab that frictionally engages the first rabbeted edge and by the second attachment tab that frictionally engages the second rabbeted edge. In another aspect of the assembly, the cover leg is formed with a thickness that runs from the leg outer surface to the cavity of at least one-eighth of an inch to accommodate installation of a hinge.

When the door frame assembly is mounted to an entryway, the mounting surface frictionally engaged with the interior surface of an entryway using nails, screws, or other fasteners that extend through the cover and base. Caulk, an adhesive, or a moisture resistant material is applied at the edges of the mounting surface to prevent moisture intrusion under the cover to the cavity that houses the base.

In one embodiment, the base is formed from a regrind material and the cover is formed from a polyvinyl chloride composite material. The regrind material can be made from 60% to 70% ground polypropylene, wood, or 60% to 70% ground polystyrene. The cover can be made from a polyvinyl chloride (“PVC”) composite by itself or extruded with one or more other thermos plastic materials such as various acrylic monomers or polymers, polymethyl methacrylate (“PMMA”), acrylonitrile butadiene styrene (“ABS”), polylactide, polybenzimidazole (“PBI”), polycarbonate, polyether sulfone (“PES”), polyoxymethylene (“POM”), polyether ether ketone (“PEEK”), polyetherimide (“PEI”), polyethylene, polyphenylene oxide (“PPO”), polyphenylene sulfide (“PPS”), polypropylene, polystyrene, polyvinyl chloride (“PVC”), polyvinylidene fluoride, and Teflon®.

### BRIEF DESCRIPTION OF THE FIGURES

Features, aspects, and advantages of the present invention are better understood when the following detailed description of the invention is read with reference to the accompanying figures described below.

FIG. 1 is a cutaway, side view of a door frame according to one embodiment.

FIG. 2 is a depicts a door frame installed in an entryway.

FIG. 3 is a first side, perspective view of a door frame according to one embodiment.

FIG. 4 illustrates voids cut into the base.

FIG. 5 illustrates a routed cutout to accommodate a hinge affixed to the frame.

FIG. 6 is a second side, perspective view of a door frame according to one embodiment.

FIG. 7 is a side, cutaway view of a door frame according to one embodiment with example dimensions.

FIG. 8 is a side view of door frame cover according to one embodiment.

FIG. 9 is a top view of door frame cover according to one embodiment.

FIG. 10 is a bottom view of door frame cover according to one embodiment.

FIG. 11 is a side view of door frame base according to one embodiment.

FIG. 12 is a perspective view of door frame base according to one embodiment.

FIG. 13 is a top view of door frame base according to one embodiment.

FIG. 14 a bottom view of door frame base according to one embodiment.

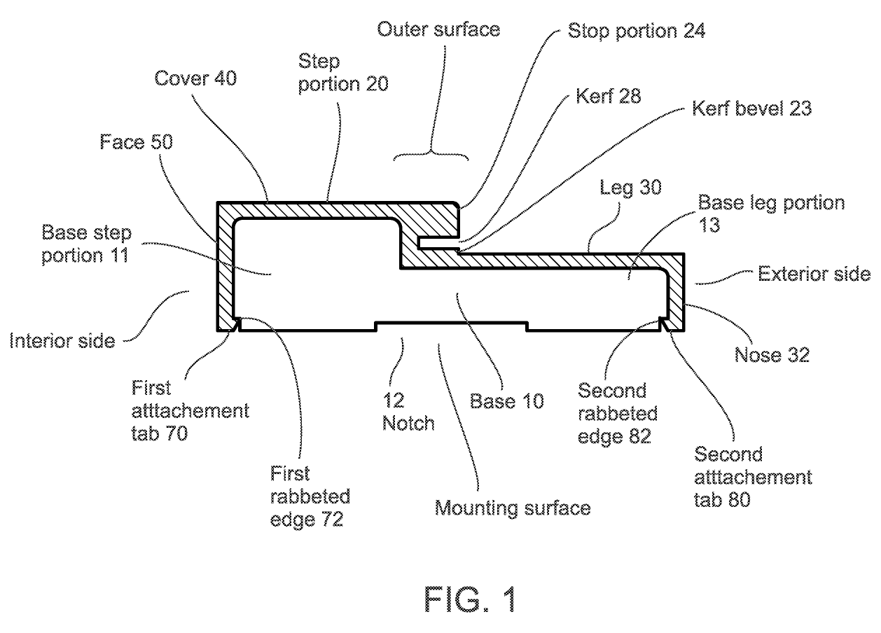

### DETAILED DESCRIPTION

The present invention will now be described more fully hereinafter with reference to the accompanying pictures in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Relative terms such as lower or bottom; upper or top; upward, outward, or downward; forward or backward; and vertical or horizontal may be used herein to describe one element’s relationship to another element illustrated in the figures. It will be understood that relative terms are intended to encompass different orientations in addition to the orientation depicted in the drawings. By way of example, if a component in the drawings is turned over, elements described as being on the “bottom” of the other elements would then be oriented on “top” of the other elements. Relative terminology, such as “substantially” or “about,” describe the specified materials, steps, parameters, or ranges as well as those that do not materially affect the basic and novel characteristics of the claimed inventions as whole (as would be appreciated by one of ordinary skill in the art).

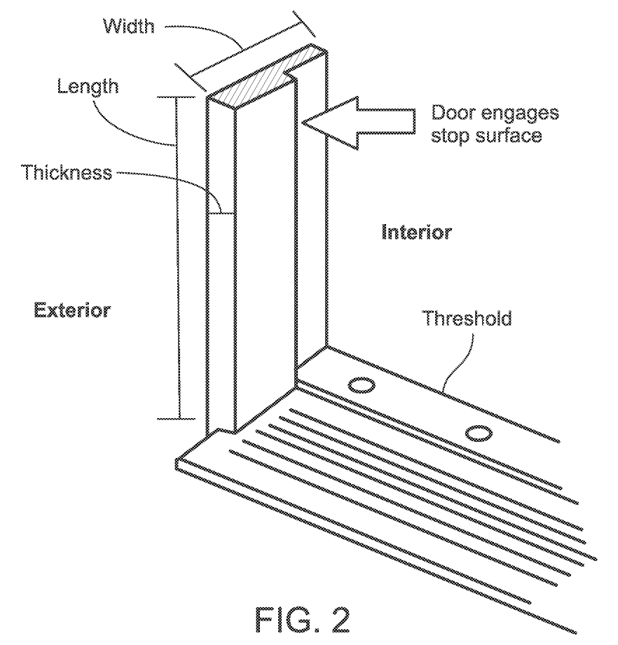

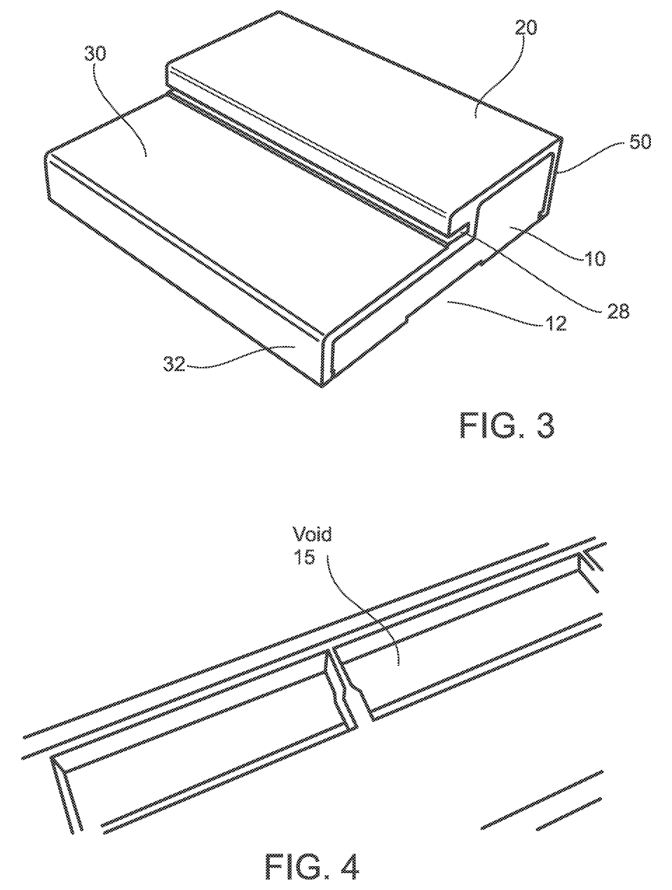

The durable door frames depicted in the attached Figures includes a base 10 and a cover 40. The cover 40 includes a cavity 42 that fits and completely encloses all sides of the base 10 except for a mounting surface that abuts an entry way surface after installation, as depicted in FIG. 2. The door frame cover 40 includes a nose 32, a leg 30, a kerf bevel 23, a kerf 28, a stop portion 24, a step portion 20, and a rear face 50. The cover 40 is fixed to the base 10 using a first attachment tab 70 that frictionally engages a first rabbeted edge 72 and a second attachment tab 80 that frictionally engages a second rabbeted edge 82. The cover 40 can further be fixed to the base 10 using a variety of adhesives (e.g., glue) or a layer of lamination.

The step portion 20 includes an outer surface that extends along the first axis between the rear face 50 and the stop portion 24. The rear face 50 and the stop portion 24 extend away from the step portion 20 outer surface in a perpendicular fashion along a second axis that is perpendicular to the first axis. The rear face 50 extends away from the step portion outer surface along a length that defines the thickness of the door frame at the step portion 20. The rear face 50 extends from a fixed end at the step portion 20 to a free end that optionally includes a first attachment tab 70.

The stop portion 24 extends away from the step portion outer surface to the kerf 28. The leg 30 has an outer surface that extends from a kerf channel opening along the first axis to the nose 32. The nose 32 extends perpendicularly away from the leg outer surface along the second axis for a length that defines the thickness of the frame at the leg 30. The nose 32 extends from a first fixed end adjacent to the leg outer surface to a free end that optionally includes a second attachment tab 80.

As shown in FIG. 2, the cover 40 and base 10 extend from an exterior side of a structure to an interior side of a structure along a first axis to define a width of the frame. FIG. 2 depicts the frame installed vertically in an entryway. The door frame has a length that extends along a third axis from the threshold at the bottom of FIG. 2 to the top of the frame.

The cover 40 is formed with a thickness that runs from the outer surface to the cavity 42 such that the cover 40 can accommodate a routed cutout to receive a hinge, as depicted in FIG. 5. A typical hinge thickness is .1 to .25 inches, and the cover 40 is sized to be thicker than the hinge to leave cover material remaining after a cutout for the hinge is formed. In this manner, when a faster is placed through the hinge to fix the hinge to a door frame, the fastener is housed within both the cover material and the underlying base material. The cover 40 should generally be.125 inches or thicker depending on the size of hinge to be used. The cover 40 thickness is a significant distinction from existing frames and that use only a very thin veneer that does not provide mechanical strength or durability but is instead intended to serve only aesthetic purposes.

The base 10 includes a base step portion 11, a notch 12, a base leg portion 13, a base rear wall 17, a base nose 18, and a base stop portion 19. The base rear wall extends perpendicularly from the mounting surface to a base step portion outward-facing surface that runs along the first axis and is approximately co-extensive with the cover outer surface. The base also includes a step surface that extends between the base step portion outward facing surface and the base leg portion 13. The base leg includes a base leg outward-facing surface that extends along the first axis between the base stop surface to the base nose.

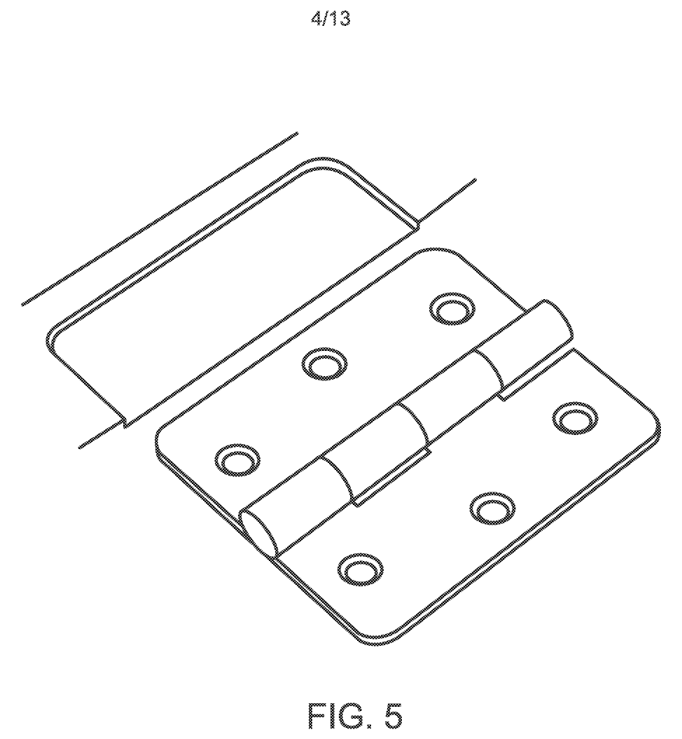

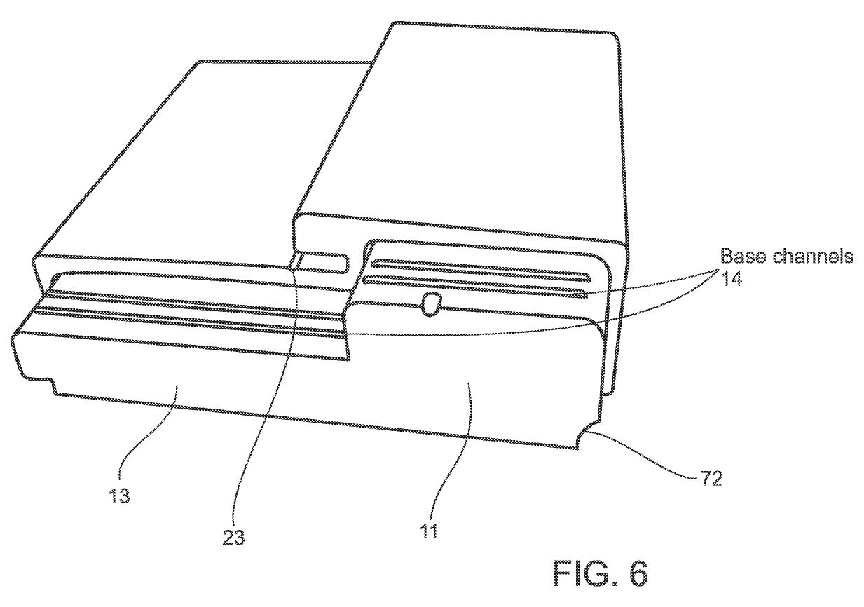

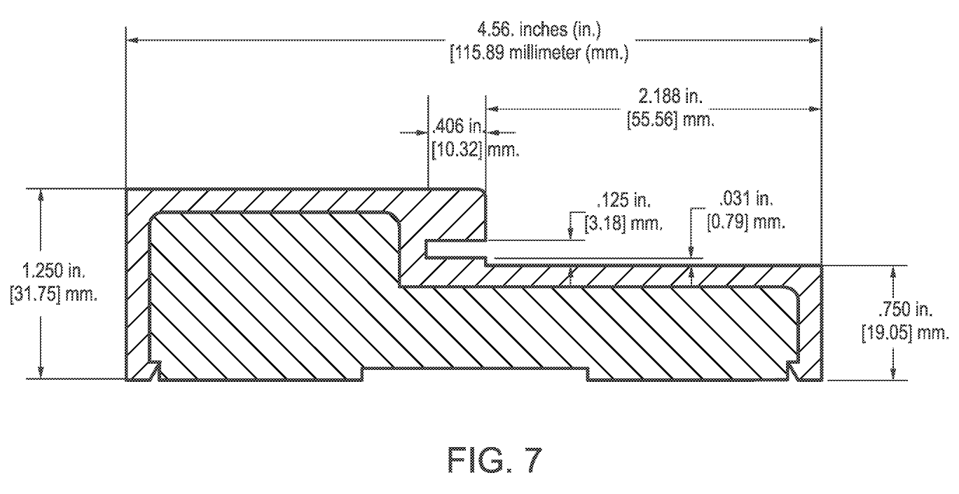

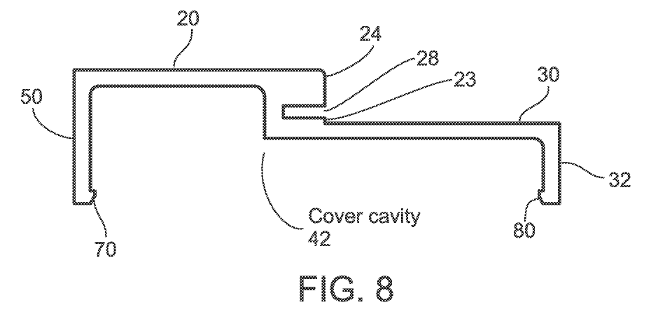

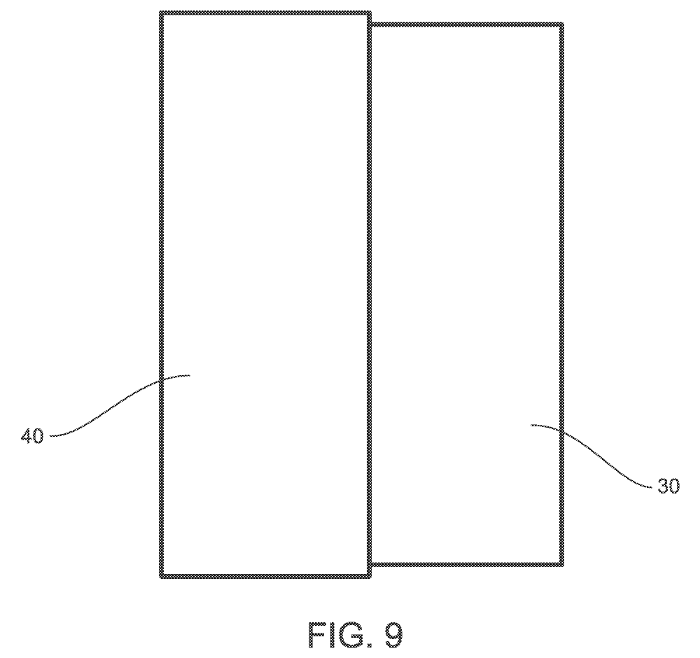

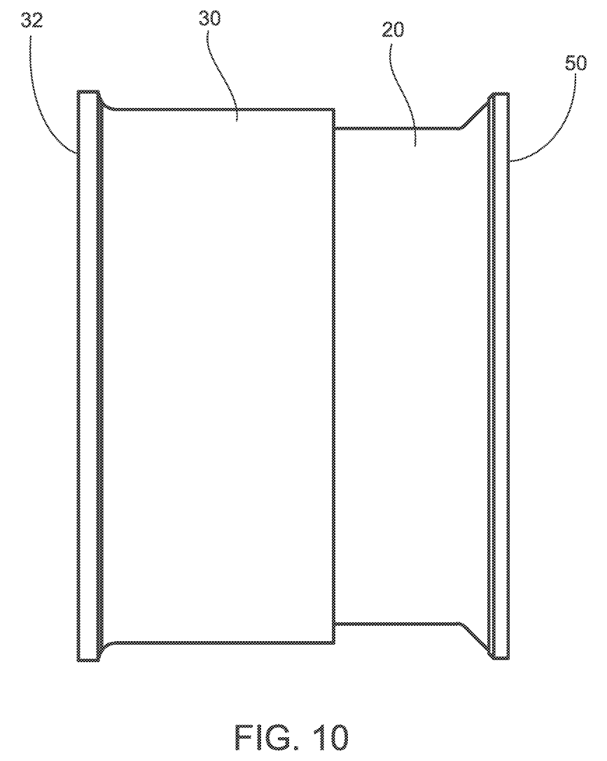

In some embodiments, the base 10 includes one or more channels 14, as shown in FIG. 4. The notch 12 and channels 14 extends continuously through the length of the base, resulting in the use of less material, which reduces weight and manufacturing cost, without impacting the structural integrity of the frame. In some embodiments, the base 10 can include one or more voids 15 that are shaped as deep cutouts into the mounting surface or bottom of the base to reduce thickness at certain portions of the base 10. This has the advantage of saving material and reducing manufacturing and shipping cost. The voids 15 are spaced a distance apart so as to leave some portions of the base 10 that extend the full thickness where such thicker portions can accommodate fasteners (e.g., nails or screws) driven through the base 10 to fix the frame to the wall of an entryway.

The stop portion 24 makes frictional contact with a door when the door is closed. The step portion 24 overhangs the leg 30 to create a kerf 28. The kerf 28 comprises an interior surface that defines a channel and a channel opening. The kerf 28 accepts a weatherstrip that serves to prevent moisture and air from entering the interior of a building and to enhance thermal insulation. The kerf bevel 23 is a small groove or channel formed on the surface of the leg 30 proximate to the kerf channel opening. The kerf bevel 23 accommodates and holds the weatherstrip by providing a frictional surface that engages features on the weatherstripping (not shown). The kerf bevel 23 can also form an additional barrier for moisture by providing space for the weatherstripping to deform and contact both the outer surface of the leg 30 and the inner surface of the kerf 28. The weatherstripping is formed from a pliable material that makes frictional contact with the interior surface of the kerf 28 as well as at least part of the outer surfaces of the leg 30 and the stop portion 24.

The cover 40 extends over the entirety of the base step portion 11, base leg portion 13, base rear wall 17, base nose 18, and a base stop portion 19. The height of the base step portion 11 is approximately equivalent to the length of the rear face 50 less the thickness of the cover material at the step portion 20. Thus, the free end of the rear face 50 is level or co-terminal with the base mounting surface so that the rear face free end an the mounting surface both contact the interior surface of an entryway during installation. Similarly, the height of the base nose 18 is approximately equivalent to the length of the nose 32 less the thickness of the cover material at the leg portion. In this manner, the free end of the nose 32 sits level or coterminal with the base mounting surface so that the nose free end and the mounting surface contact the interior surface of an entryway during installation..

During installation, the base and cover are secured to an interior surface of an entryway using adhesives or fasteners such as nails or screws. The base and cover are caulked at the ends proximal to the first and second rabbeted edges to create a moisture barrier such that moisture does not reach the base. Those of skill in the art will appreciate that any caulk or sealant suitable to provide a moisture barrier can be used, such as polyurethane, silicone, latex, vinyl latex, acrylic latex, adhesive caulking, polyurethane foam, butyl-rubber caulking or sealants. The cover provides a durable barrier to moisture intrusion. Durability is enhanced for embodiments that utilize a base made from PVC composite or virgin regrinding material, which are both, moisture resistant.

The cover 40 or the base 10 can be made from thermoplastic materials that have superior mechanical, thermal, aesthetic, and other properties as compared to conventional door frame assemblies. Moreover, the cover 40 and base 10, when made from thermoplastic materials, are lighter and more cost effective over their solely wood counterparts. Thermoplastic materials can include PVC composite materials as well as polypropylene and polystyrene materials. As one example, the cover 40 or base 10 can be made from a polyvinyl chloride (“PVC”) composite material that includes (1) PVC; (2) calcium; (3) grinding material; (4) wood flour; (5) acrylic processing aid; (6) 118A stabilizer; (7) stabilizer; (8) AC foaming agent; (9) white foaming agent; (10) 629 polyethylene wax; (11) polyethylene wax; and (12) 1801 stearic acid.

The PVC composite material has the advantage of high tensile strength, scratch resistance, high ultraviolet (UV) light tolerance, chemical resistance, and the PVC composite can be processed using a variety of techniques, such as extrusion, injection molding, physical cutting, laser cutting, welding, among others. The PVC composite material has good aesthetic qualities as it readily accepts pigments, can be imprinted with designs, and is easy to clean as it does not permit materials to stick to its surface. Moreover, the PVC composite material prevents mold, mildew, salt and termites from sticking to or penetrating the cover and base. Furthermore, use of a PVC composite material provides additional cost benefits over entirely PVC components.

The high tensile strength and thickness of the PVC composite material are able to hold screws or nails that may be affixed into the frame. Unlike convention frames where screws are secured into the core, with no structural support from the outside cover or veneer, the cover described herein provides additional structural support and bears the weight of objects affixed to the frame, including for example door hinges.

The PVC composite can be formed with particular colors or patterns that extend through the entire material as opposed to a painted color coating. In this manner, the door frame maintains color in the face of not only potential damage from UV rays but also from mechanical damage (e.g., scratches, cracks, dents, etc.) that might otherwise remove a color coating leading to a degradation in the aesthetic qualities of the door frame.

The cold and heat resistance, chemical resistance, and impact resistance of PVC composite material is enhanced using one or more impact modifiers where the impact modifiers can be, but are not limited to, acrylate monomers or acrylate polymers present in a range from 10% to 50% and preferably from 35% to 45%. The impact modifier can be comprised of, for instance, methyl methacrylate, methyl methacrylate-butadiene-styrene (“MBS”), polybutyl acrylate (“PBA”), or various polyacrylate polymers. In one embodiment, the components of the door frame assembly are formed using a thermoplastic material, such as the PVC composite, that is reinforced with nylon fibers, which can serve as an impact modifier and which are suited for use in an extrusion process, to provide enhanced mechanical performance, durability, and thermal resistance.

The base 10 material can also be formed from wood or a virgin regrinding material that comprises 60% to 70% ground polystyrene or polypropylene. Virgin regrinding material, such as polystyrene and polypropylene, offer many benefits over other types of core materials, including non-absorbency, reusability, sustainability, durability, reduced weight, and cost savings. The virgin regrinding materials also have the advantage of being more readily available starting from a recycled source materials, thereby being ecologically sustainable and efficient. More specifically, the polystyrene material can be a high-impact styrene-butadiene copolymer (CAS No. 9003-55-8), and the polypropylene can be a polypropylene resin.

Furthermore, wherein frames using solid pieces of wood require multiple wood pieces joined at finger joints, the base and cover can each be manufactured in a single length that extends across the height or width of an entryway. This aspect not only reduces costs, but also decreases the breaking points or points fracture or weakness in the overall frame. Those of skill in the art will appreciate that various types of thermoplastics can be used to form the components of the door frame assemblies disclosed herein, including, but not limited to, various acrylic monomers or polymers, polymethyl methacrylate (“PMMA”), acrylonitrile butadiene styrene (“ABS”), polylactide, polybenzimidazole (“PBI”), polycarbonate, polyether sulfone (“PES”), polyoxymethylene (“POM”), polyether ether ketone (“PEEK”), polyetherimide (“PEI”), polyethylene, polyphenylene oxide (“PPO”), polyphenylene sulfide (“PPS”), polypropylene, polystyrene, polyvinyl chloride (“PVC”), polyvinylidene fluoride, and Teflon®.

In one embodiment, the cover or base are formed using an extrusion process. The advantages of utilizing an extrusion process to form the outer surfaces as opposed to other processes, such as injection molding, include the ability to create laminar structures that are less porous with increased density, impact resistance, and resistance to shattering. Generally polystyrene or polypropylene are suitable for use with an extrusion process.

In another embodiment, a “white cap” is formed over the cover using the coextrusion process described above. The white cap is a thin layer of PVC that is blue-white pigment to brighten up the color of the cover. The white cap provides a pre-finish to the door frame.

In yet other embodiments, a PVC composite material or virgin regrinding material can be used to form the bulk of the various components using injection molding or extrusion while the outer surface or skin of the components is formed using a combination of extruded materials with impact modifiers and extruded PVC. In this manner, the bulk portion of the components can be made from a lighter material that reduced manufacturing and shipping costs while the outer surfaces are made from scratch resistant, shatter resistant, UV resistance, heat resistant, chemically resistant, and aesthetically advantageous material.

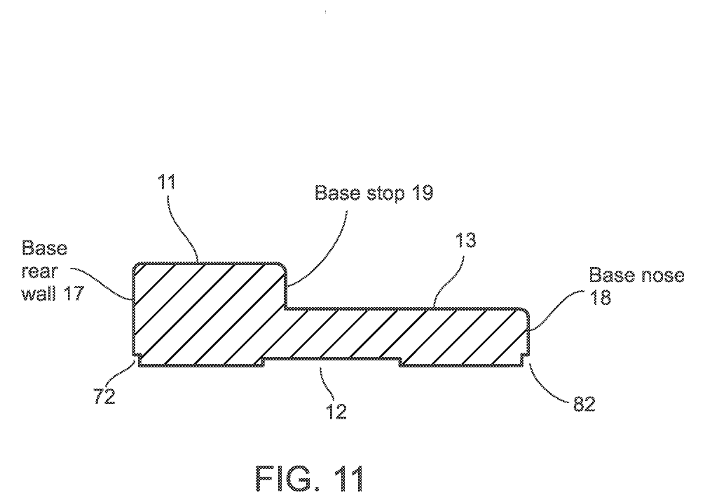

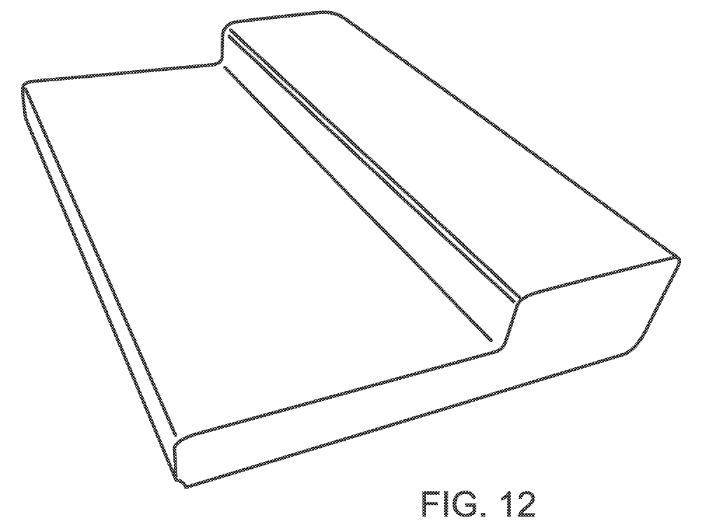

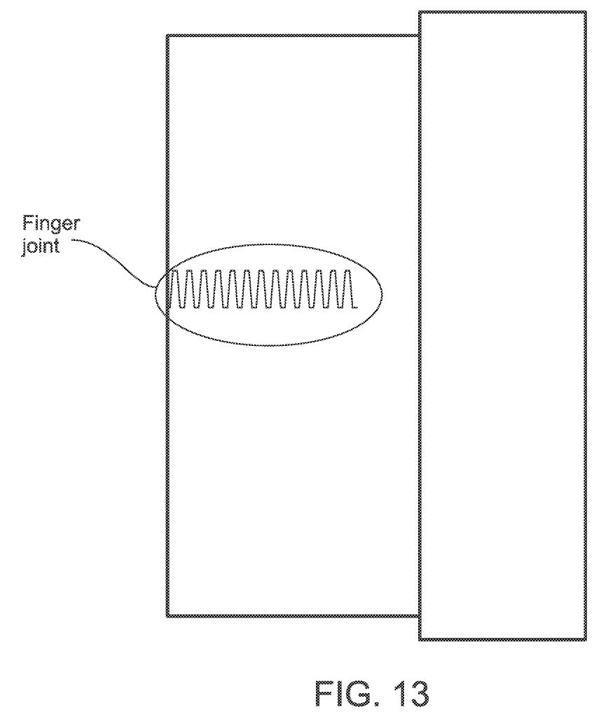

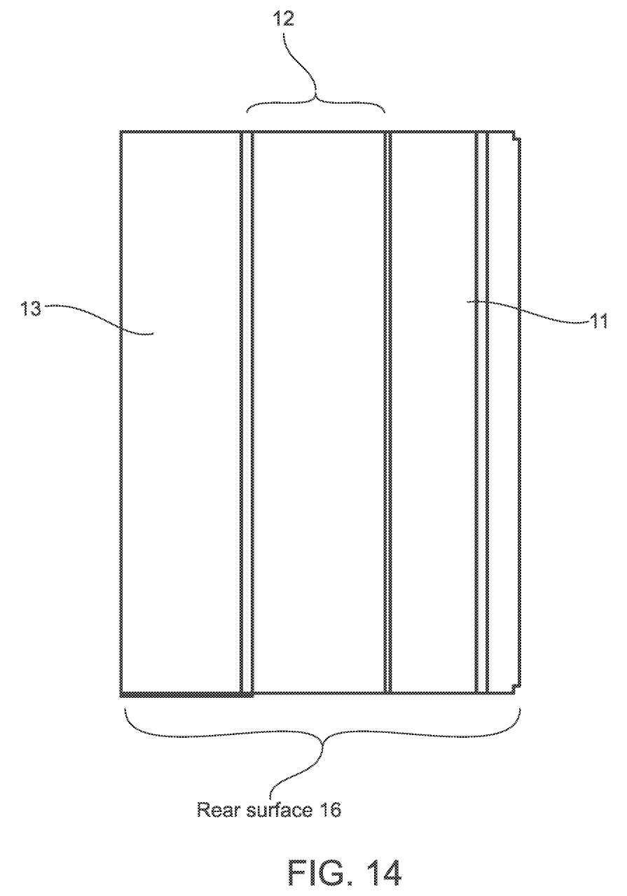

The use of injection molding to form various components has the advantage of permitting the formation of door frame components with more complex geometries. For example, injection molding permits formation of the voids shown in FIG. 4 and more efficient formation of the attachment tabs and rabbeted edge features. Thus, injection molding permits components to be formed with features that permit tool-free, snap fit assembly or features that save weight, such as channels or cutouts, as illustrated in the attached figures. The virgin polypropylene regrinding material is generally better suited than polystyrene for use with an injection molding process to form the unitary base components that are shown in the attached figures, including FIGS. 11-14.

The enhanced properties of the PVC composite and virgin regrinding materials are achieved while still reducing the cost of door frame manufacturing over conventional door frame materials. Conventional door frame materials, such as aluminum are costly and subject to sudden and wide price fluctuations, supply chain availability constraints in both the United States and overseas due to varying tariffs or regulatory barriers, and require additional costly processing steps during manufacturing, such as anodization. Thermoplastic materials have the advantage of avoiding such cost and supply chain constraints, and are less expensive and easier to process as they do not require anodization, and the cost of extruding or injection molding the materials to the desired form is significantly less than the cost of extruding aluminum. The thermoplastic materials used to form the door frames disclosed herein are more durable, dent resistant, and lighter weight than existing door frame materials. The materials are also chemically resistant to a wide range of substances such that they are not subject to corrosion from paints, finishes, cleaners, various other construction or household materials. Thermoplastics in particular also have the advantages of being recyclable and capable of being remolded.

In some embodiments, the door frame components incorporate an UV light inhibitor that enhances resistance to damage and color fading from sunlight for up to ten years. The UV light inhibitor is provided as an additive to the thermoplastic materials. The composition of the UV light inhibitor can vary depending on the properties and composition of the thermoplastic materials used to form the door frame components as well as the particular cost concerns, among other factors. Suitable UV light inhibitors can include, for instance, combinations of carbon black, rutile titanium oxide, hydroxybenzophenone, hydroxyphenylbenzotriazole, oxanilides for polyamides, benzophenones for PVC materials, and benzotriazoles and hydroxyphenyltriazines for polycarbonate materials, or Hindered Amine Light Stabilizers (“HALS”), among other compounds known to those of skill in the art.

The improved thermal properties of the thermoplastic materials, including specifically the virgin regrinding material, can create a thermal break that improves energy efficiency within the associated building structure. The virgin regrinding and PVC composite materials have the additional advantage that they do not facilitate condensation as in metallic door frames.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A door frame assembly comprising:
(a) a cover that defines a cavity, wherein the cover comprises
(i) a step portion having a rear face,
(ii) a stop portion,
(iii) a step portion outer surface that extends along a first axis from the rear face to the stop portion, wherein
(A) the rear face extends away from the step portion outer surface along a second axis that is perpendicular to the first axis,
(B) the rear face is coupled to the step portion outer cover and extends a first length along the second axis and terminates at a first free end;
(C) the stop portion extends along the second axis away from the top surface to a kerf, and
(D) the kerf comprises an interior surface that defines a channel and a channel opening,
(iv) a leg comprising a leg outer surface, wherein
(A) the leg outer surface extends from the channel opening along the first axis to a nose,
(B) the nose extends away from the leg outer surface along the second axis,
(C) the nose is coupled to the leg outer surface and extends a second length along the second axis and terminates at a second free end, and
(D) the cavity is at least partially enclosed by the rear face, the step portion, the kerf, the leg, and the nose;
(b) a base that is configured to be housed at least partially within the cavity, wherein the cavity encloses all surfaces of the base except for the mounting surface.

2. The door frame assembly of claim 1, wherein
(a) the cover comprises
(i) a first attachment tab formed at the rear face first free end, and
(ii) a second attachment tab formed at the nose second free end;
(b) the base mounting surface extends along the first axis between a rear wall and a base nose;
(c) the rear wall extends away from the mounting surface along the second axis;
(d) the base nose extends away from the mounting surface along the second axis;(
e) the base comprises (i) a first rabbeted edge formed proximal to an intersection of the mounting surface and the rear wall, and (ii) a second rabbeted edge formed proximal to an intersection of the mounting surface and the base nose; and
(f) the cover is secured to the base by the first attachment tab that frictionally engages the first rabbeted edge, and by the second attachment tab that frictionally engages the second rabbeted edge.

3. The door frame assembly of claim 1, wherein the cover is secured to the base by an adhesive or by a layer of lamination.

4. The door frame assembly of claim 1, wherein the cover leg is formed with a thickness that runs from the leg outer surface to the cavity of at least one-eighth of an inch.

5. The door frame assembly of claim 1, wherein:
(a) the mounting surface is frictionally engaged with an interior of an entryway; and(b) a caulk is applied to a first end of the mounting surface proximal to rear face and to a second end of the mounting surface proximal to the nose.

6. The door frame assembly of claim 1, wherein the base is formed from a regrind material and the cover is formed from a polyvinyl chloride composite material.

7. The door frame assembly of claim 5, wherein the regrind material comprises 60% to 70% ground polypropylene.

8. The door frame assembly of claim 7, wherein the base is formed using injection molding.

9. The door frame assembly of claim 6, wherein the regrind material comprises 60% to 70% ground polystyrene.

10. The door frame assembly of claim 1, wherein the cover is made from a first thermoplastic material and a polyvinyl chloride material.

11. The door frame assembly of claim 10, wherein the first thermoplastic material is polymethyl methacrylate with at least one impact modifier.

12. The door frame assembly of claim 10, wherein the first thermoplastic material further comprises nylon fibers.

13. The door frame assembly of claim 1, wherein the base includes one or more channels that extend continuously through the length of the base.

14. The door frame assembly of claim 13, wherein the one or more channels are made by injection mold.

15. The door frame assembly of claim 1, wherein a weather strip is installed within the kerf.

16. A door frame assembly comprising:
(a) a cover that defines a cavity, wherein the cover comprises
(i) a step portion having a rear face,
(ii) a stop portion,
(iii) a step portion outer surface that extends along a first axis from the rear face to the stop portion, wherein
(A) the rear face extends from the step portion outer surface along a second axis that is perpendicular to the first axis, and along a first length that terminates at a rear face free end,
(B) the stop portion extends along the second axis away from the top surface to a leg outer surface,
(C) the leg outer surface extends from the stop portion along the first axis to a nose, and
(D) the nose extends away from the leg outer surface along the second axis, and along a second length that terminates at a nose free end; and
(b) a base housed at least partially within the cavity, wherein the base comprises
(i) a mounting surface that extends between a rear wall and a base nose along the first axis,
(ii) a base step portion comprising the rear wall, a base step portion outward-facing surface, and a base stop surface, wherein (A) the rear wall extends along the second axis between the mounting surface and the base step portion outward-facing surface, and (B) the base stop surface extends along the second axis away from the base step portion outward-facing surface,
(iii) a base leg portion comprising a base leg outward-facing surface that extends along the first axis between the base stop surface to the base nose, wherein the base rear wall, the base step portion outward-facing surface, the base stop surface, the base leg outward-facing surface, and the base nose are all proximal to and at least partially coextensive with the cover.

17. The door frame assembly of claim 16, wherein:
(a) the mounting surface is fixed to the interior of an entryway;
(b) a caulk is applied to a first end of the mounting surface proximal to rear face and to a second end of the mounting surface proximal to the nose.

18. The door frame assembly of claim 17, wherein the base is formed from a materials selected from one of (i) a regrind material comprising 60% to 70% ground polypropylene, (ii) a regrind material comprising 60% to 70% ground polystyrene, or (iii) wood.

19. A door frame assembly comprising:
(a) a cover that defines a cavity, wherein the cover comprises
(i) a step portion having a rear face,
(ii) a stop portion,
(iii) a step portion outer surface that extends along a first axis from the rear face to the stop portion, wherein
(A) the rear face extends away from the step portion outer surface along a second axis that is perpendicular to the first axis,
(B) the rear face is coupled to the step portion outer cover and extends a first length along the second axis and terminates at a first free end;
(C) the stop portion extends along the second axis away from the top surface to a kerf, and
(D) the kerf comprises an interior surface that defines a channel and a channel opening,
(b) a base that is configured to be housed at least partially within the cavity, wherein
(i) the cavity encloses all surfaces of the base except for the mounting surface,
(ii) the mounting surface is coterminal with the nose free end and the rear face free end,
(iii) the mounting surface is fixed to the interior of an entryway,
(iv) a moisture barrier is applied to a first end of the mounting surface proximal to rear face and to a second end of the mounting surface proximal to the nose.

20. The door frame assembly of claim 19, wherein the base is formed from a materials selected from one of (i) a regrind material comprising 60% to 70% ground polypropylene, (ii) a regrind material comprising 60% to 70% ground polystyrene, or (iii) wood.
